(19) United States
(12) Patent Application Publication
(10) Pub. No.: US 2023/0325399 A1
(43) Pub. Date: Oct. 12, 2023

(54) Method, Apparatus and System for a Unified Database for Academic and Organizational Processes and their Evaluations using Data Analytics

(71) Applicant: Disha Raghuvanshi, Union City, CA (US)

(72) Inventor: Disha Raghuvanshi, Union City, CA (US)

(21) Appl. No.: 17/717,125

(22) Filed: Apr. 10, 2022

(51) Int. Cl. G06F 16/25; G06F 11/34; G06N 20/00; G06F 9/50

(52) U.S. Cl. CPC G06F 16/254; G06F 11/3409; G06N 20/00; G06F 9/5072; G06F 2216/03

(57) ABSTRACT

A dedicated database system for a school, college or university is proposed which is capable of providing whole analytical insights to all aspects of academic business and organization. This enables users to obtain and analyze business data from a plurality of sources, manipulate and store and then after reformatting, to apply machine learning and other algorithms to obtain analytical information for past and present state and future predictions. The database system is also capable of listing and itemizing key parameters and data which shall have major improvements in the metrics of interest for the education institutions. The database system is capable of cloud installation, enabling online updates of versions and improvements in performance, in a transparent way to the user.

### FIELD OF THE INVENTION

The present invention relates generally to databases and their manipulations. More specifically, the present invention proposes a method, apparatus and system for users to build, import and input data into a database structure for a school, college or university and manipulate it by prescribed steps to be able to obtain analytical insights to determine present status and to avail of analytics to project and predict future performances.

### BACKGROUND OF THE INVENTION

Whereas some businesses anticipate that an Enterprise Resource Planning (ERP) solution is the only business management software they need to streamline and run their business efficiently and smoothly, in reality, that is not the case. Every business and industry, including educational institutions have their own unique set of requirements. ERPs are designed to provide the solid foundation of a business management solution, while allowing businesses to choose the precise complementary software they need to supplement to make their solution ideally suited to their specific needs. An issue arises if ERP cannot integrate with the complementary solutions that are needed. Case in point are educational institutions which demand their own business management solution as well as set of complementary software.

Initially, ERP systems were developed to provide core data storage for Financial, CRM (Customer Relationship Management), and Manufacturing and Supply Chain data. Typically, ERP systems also included some human resource data capacity, but usually focused on payroll functions. For a variety of reasons, however, human resources departments choose their own course, seeking best of the lot HCM (human capital management) solutions as human resources requirements became more complex and demanding. HCM or Human Resource Management Systems (HRMS) expanded to include hiring, benefits administration, performance management and compliance to regulation aspects. Ad hoc approach to reporting, data analysis and control of the payroll function made stand-alone HCM/HRMS systems desirable to human resource departments, providing an increasingly complex single integrated point concerning all aspects of the employee life cycle from hire to retire. Linked to HCM/HRMS systems were employee portals for self-service, benefit enrollment, time off management and time and attendance. Often the link between ERP and HCM was reduced to export of general ledger entries post-payroll. As is evident, a similar good solution in this space for school, college or university (educational institution) is lacking.

In addition, data from the different systems can complement each other and provide new insights. ERP systems can access important HCM data to use employee and team performance to determine training needs and monitor and review results to see if output increases. This can also determine whether employee turnover rates in a particular area impact revenues, use HCM data on employee skills and certifications in seeking new projects and facilitate professional services automation in ERP, and incorporate workforce management functions like time and attendance into job costing function analysis. HR can use ERP data to use relevant ERP data (margins, revenue, profit, time-to-cash) in on job performance reviews, include CRM data from customer support, professional service and sales to support planning and training levels, and link payroll functions like expense reimbursement, asset assignment, general ledger, and commissions directly into ERP. Integrated systems can lead to greater efficiency, better decision-making and a better experience for employees, customers and internal stakeholders. No good solution exists for integrated database development and management for educational institutions at school, college and university level. In fact, there is no analytics software product that is tailor made for education industry today.

This proposal has recognized that the rich data held in the HCM and like databases can be used to make better strategic decisions for the organization. This use and analysis of human resources and other departments' “big data” has led innovative companies to consider reintegration of data between the different systems. One significant driver for integration is to reduce input of human resources and payroll transactional data. Multiple data entry increases time spent on administrative tasks and can result in data entry errors. Errors, in turn, can erode confidence in the analysis and resulting insights. A unified database also makes reporting and analysis richer and more in depth as well as easier to run. Rather than reporting from a patchwork of disparate sources—databases, files and spreadsheets—a single database makes report development quicker and easier to maintain. This, in turn, makes data available to decision-makers in closer to real time. Some solutions help colleges/universities evaluate candidates and predict their matriculation probability based on set of criteria. Basically, this helps colleges/universities predict yield better in terms of student potential and output. Another set talks about how data from different online educational systems can be collected at one place and summarized information can be viewed by parent, student, and education provider. However a comprehensive solution for school, college or university is lacking.

Reputed enterprise business application companies such as SAP, Oracle, Salesforce, Workday etc. sells enterprise ERP, HCM, CRM software, which an educational institution can use. Such software helps automate educational institution's Financial, Marketing or Human Resources business functions. They may include a report or two with their software to solely do reporting. Reporting is just a simple tabular data dump. It does not provide insights. If an educational institution seeks insight, it needs to perform data analysis manually. Example: perform analysis of finance data to understand areas it is doing well and areas it may not be. Institution will need to run the finance report(s) to get a data dump, download data into spreadsheet and analyze data manually using a Microsoft Excel to make sense of data. This requires particular skillsets, which usually a business or data analyst can possess. The data analysis process can be cumbersome and daunting. However, this is what most of the educational institutions are doing today to gain insights. Additionally, these enterprise companies do sell their Analytics software product but they are sold separately from enterprise software and can be very expensive. They are built to help big corporations, and will provide insights and help improve finance or human resource or similar business functions only. They would not provide Analytics to help student gain insight into his/her performance, layout plan, help with course selection, receive recommendation, or improve performance. Similarly, they would not provide analytics to help educational institution improve curriculum effectiveness or student engagement. This is where the present invention offers a solution. The software is developed keeping only educational institution's business functions in mind. It will automate consolidation of institution's HCM, finance, marketing, admissions, students, courses, academic performance, graduation, matriculation, athletic programs, surveys, assets etc. data at one place, treat data to extract information out of it, and eventually enable meaningful insights into every business function of the institution—all automated. The solution will also allow external datasets, stored in file format, to be uploaded into the integrated database for blended insights.

### BRIEF DESCRIPTION OF THE DRAWINGS

FIG. 1 is one embodiment of a system diagram illustrating the invention. It represents various users, models inputs and outputs of the invention. A scalable function is provided from running the institution to guiding the institution through generation of analytics and insights. The users of the invention are students and institution faculty members.

FIG. 2 is one embodiment of the overall architecture of the invention, showing various steps, inputs and interactions between steps. Data sources are inputted. They go through extraction, transformation and load steps. First, data is extracted from data sources using ETL (Extract, Transform and Load) process. Second, extracted data is then placed in a holding area called staging area. Third, data transformation rules are applied to required datasets from stage area and loaded into unified data warehouse comprising of metadata, summary data and raw data. Next, data from the warehouse is blended together in Analytics layer to create prebuilt reporting, analytics (insights with key performance indicators, scorecards, visualizations etc.), and advanced analytics (forecast, prediction, and recommendation) content. User will access prebuilt integrated analytical content to gain insights into educational institution's complex business processes, evaluate efficiency & effectiveness, and take informed decisions. The data sources are relevant to educational institution in school, college and university.

FIG. 3 is an illustration of all the steps involved in the database manipulations to consolidate and input all data, prepare the data for read in through extraction, transformation and load steps. Using big data and user inputs, basic and advanced analytics insights are generated to run and guide business operations of educational institution e.g. school, college or university.

FIG. 4 is an illustration of one embodiment of one instance of a large fact table and a plurality of dimension tables linked to each other through use of foreign keys. The illustration is exemplary of an educational institution (school) with dimension tables for year, student, location and branch.

### DETAIL DESCRIPTIONS OF THE INVENTION

All illustrations of the drawings are for the purpose of describing selected versions of the present invention and are not intended to limit the scope of the present invention.

In the following description specific details are set forth describing certain embodiments. It will be apparent, however, to one skilled in the art, that the disclosed embodiments may be practiced without some of these entire specific details. The specific embodiments presented are meant to be illustrative, but not limiting. One skilled in the art may realize other material that, although not specifically described herein, is within the scope and spirit of this disclosure. For purposes of this disclosure, proposed framework system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, framework system may be a hardware device of size, shape, performance, functionality, and price. In another embodiment, it may comprise of software components capable of being loaded to run on a hardware device. The framework system may include random access memory (RAM), one or more processing resources such as a central processing unit (CPU) or hardware or software control logic, read only memory (ROM), and/or other types of nonvolatile memory. Additional components may include one or more disk drives, one or more network ports for communicating with external devices as well as various input and output (I/O) devices, such as a keyboard, a mouse, and a video display. The framework system may also include one or more buses operable to transmit communications between the various hardware components. The framework system may be dedicated system of hardware and software. In another embodiment, it may constitute transferable software code loadable and runnable on a general purpose computer system.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. Unlike this, the proposed invention is neither related to online educational systems nor collecting data from it. Invention is to collect data for all business functions of an educational institution (in-person learning), organize it in a pre-built database organization structure, build an analytics layer over it by blending data for complex data analysis, and create reports/dashboards that will enable insights in the form of key performance indicators, scorecards, graphs/charts etc. Additionally, the proposal includes machine learning features to allow prediction of data, which is a very new technology. This solution is an end-to-end analytics solution for educational institutions where the software product will be implemented on the cloud. Services will be provided to school systems across the globe online. This eliminates the need for schools to implement any analytical software in-house, and spend money in either customizing or maintaining it. Schools just use the services and pay monthly subscription.

In one embodiment, the database management system for schools, colleges and universities is called “Erudi-Lytics.” “Erudi-Lytics” is a software product. It is hosted on the cloud. It is provided to school systems across the globe as “Software-as-a-Service” with a monthly subscription model. Product has data integration methods to source data from other software systems owned by respective schools. It also allows manual data upload. This software processes and organizes data for faster retrieval. It will apply analytical or statistical methods to produce information and enable insights by presenting data in the form of visualizations, trends, maps, scorecards, key-performance-indicators (KPIs), and many more. It will provide pre-packaged charts, graphs, and insights. It will apply machine learning technologies to learn and predict future events. It will include version of the software that can be run using a browser or hand-held device e.g. mobile phone/iPad. Mobile version of the software will be NLP (natural language process) enabled.

In one embodiment, insights enabled are—what is school's diversity like; what is the student population by subjects; what is average SAT/ACT score, and how has it been trending; what is the most and least popular subject among students and why? what is the most and least difficult AP or Honors subject based on average score; what course path a student can take for a specific career interest; what is the pass or fail rate for any specific course and overall; what have been the graduation rates in the past and predict the future; which colleges/universities are the most popular among previously graduated students; and others. In one embodiment, the software product will simplify course selection steps for student by automatically recommending number of courses depending on student's career interest, current academic performance and fulfillment of pre-requisite courses. Tool can also be used to plan for each student's daily course schedule during school year depending on courses selected by student. It will identify scheduling conflicts and recommend resolutions. This tool can be relied upon by the guidance counselor during meetings with student to discuss course selection, and student performance. It will help facilitate and steer conversation between guidance counselor and student. This product will have two usage models—basic and advanced. The basic version has pre-packaged insights for analysis and allows for basic analytics operations. On the other hand, advanced version includes all the functionalities offered in basic, and in addition it includes advanced analytics features such as predictive analytics and customizations. So, while basic version of the software allows school to run school business operations, its advanced version allow to run and guide school business operations. The proposed invention is used for use cases such as daily updates, reporting and budgeting, trend analysis, multi-source analysis, monitor key performance indicators, and perform predictive/prescriptive analytics. School faculty members and students are the users of the software. Software can be used by school faculty members for daily operations, strategic planning, risk identifications, and scenario modeling and analysis. Similarly, students can use the product for course selection, monitor performance, and receive recommendations and submit surveys/feedback.

“Erudi-Lytics” is the first of its kind that will be pre-built understanding educational institution's business processes and will include insights specific to the institution. The version of “Erudi-Lytics” which will be for high school will understand and include insights for the way high school operates. Similarly, there will be version of the software catered to universities/colleges, middle, and elementary schools. There are analytics product available in market that can be used but not without significant amount of customizations to the tool, which can be complex and expensive, and even then it may not provide visibility into all areas of business function “Erudi-Lytics” will automate processing of data, store and organize data for faster data analysis, and provide insights without the need of any additional coding or customization. Additionally, since the product will be hosted on the Cloud and provided as “software-as-a-service”, it will eliminate the need for educational institution implement and maintain software/hardware in-house. Thus, the software product is expected to save significant expenses of educational institutions. Institutes will automatically receive software and hardware updates when an update is available as a result of cloud update.

In terms of the steps first, data sources for the software product will be software systems owned by educational institution e.g. ERP (Finance), HCM (HR), CRM (Sales/Marketing), Student information systems, or any external data sources. Second, software product will use REST API to read data from above source system(s). A REST API (also known as RESTful APO is an application programming interface (API or web API) that meets the constraints of REST architectural framework and permits interaction with RESTful web services. REST stands for representational state transfer. REST is an architectural framework, not a standard or API. In one embodiment, REST is used to build distributed applications such as Web apps and Web services. REST servers are any modules of software that respond to REST requests. They can be implemented in many ways. In one embodiment, they are implemented, using Java servlets. The Web is an example of REST architecture. The many versions of software running on web servers that return resources are examples of REST servers. Web browsers are a kind of REST client, sending requests to URLs using HTTP.

As a third step, user(s) will be able to upload external data. In one embodiment, it will be a spreadsheet into the application. Fourthly, raw data is pulled from source systems and staged in a holding area. This process is called the extraction process. In one embodiment, another process namely “transform” will run next to process raw data from holding area and apply transformation rules. In one embodiment, as a final step, “load” will run to load transformed data into a specific organization style namely “star schema” model, where data will be grouped into fact and dimension objects. In one embodiment, a star schema is a database organizational structure optimized for use in a data warehouse or business intelligence that uses a single large fact table to store transactional or measured data, and one or more smaller dimensional tables that More attributes about the data. The aspects of fact and dimension will serve as the foundation for creating insights. In one embodiment, at this stage, raw data is treated and converted into information aspect.

In one embodiment, a fact table is a primary table in a dimensional model. It contains a plurality of measurements or facts. Further, it contains a foreign key to a corresponding dimension table. A dimension table comprises dimensions of a fact. One or more dimension tables are tied to fact table through the use of foreign key. The dimension tables are de-normalized. The dimension attributes are the columns in the dimension table. Through these columns, dimensions offer descriptive traits of the facts using the attributes. The dimensions may also contain hierarchical relationships. In one embodiment, fact table contains measurements, metrics and facts about a business process. A dimension table is a companion to the fact table which contains descriptive attributes, usable as query constraints.

In one embodiment, the next step is to convert information into insight. The fact data is joined with dimension data in the front end tool. This is called the business layer. In one embodiment, joined data from business layer is organized in folder structures, which is called the presentation layer. The fact folder will include calculated fields, which are called insights. Dimension folders include view by which an insight is reviewed. As an example, if the inquiry is regarding the number of students by subject in 10th grade during school year 2021-2022, the number of students is insight and subject, grade and year are dimensions. In one embodiment, pre-packaged reports and dashboards including prompts (dimensions) and insights will be created and provided with the software product. In one embodiment, hundreds of insights can be created and prepackaged providing visibility into every business function of an educational institution. In one embodiment, software product will include predictive & prescriptive analytics features, which will use machine learning technology to learn, predict event and prescribe remedial action as needed. As an example, in one embodiment, the invention can learn from past events, patterns and can predict which students may be at higher risk of dropping out of a subject even before they drop out. This will enable corrective or remedial measures taken way in advance

In one embodiment, the next step is to convert information into insight. The fact data is joined with dimension data in the front end tool. This is called the business layer. In one embodiment, joined data from business layer is organized in folder structures, which is called the presentation layer. The fact folder will include calculated fields which is called insight. Dimension folder includes views by which an insight is reviewed. As an example, if the inquiry is regarding the number of students by subject in 10th grade during school year 2021-2022, the number of students is insight and subject, grade and year are dimensions. In one embodiment, pre-packaged reports and dashboards including prompts (dimensions) and insights will be created and provided with the application. In one embodiment, hundreds of pre-packaged insights can be created and prepackaged providing insights into every business function of school. In one embodiment, application has predictive analytics feature, which will use machine learning technology to learn and predict future event. For example, in one embodiment, the invention can learn from past events, patterns and can predict which students can be at risk to drop out of a subject even before they drop out. Corrective or remedial measures can then be taken in advance.

In one embodiment software product includes a survey module that enables the institution to conduct survey using a questionnaire model through which students and parents can provide valuable improvement feedback. Students may provide regular feedback anonymously. The product analyzes feedback documented in natural language automatically, using text analytics, and performs sentiment analysis to highlight top areas of improvements. In one embodiment, software product provides insight into various metrics around survey data. In one embodiment, it also provides capability to measure improvements year over year.

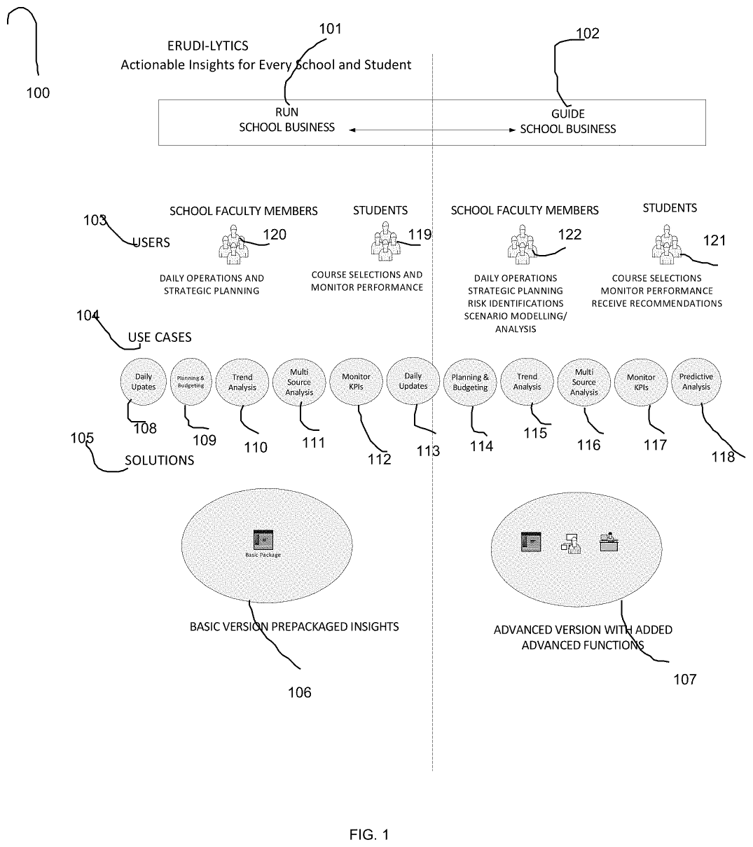

FIG. 1 100 is illustrative of a top level system diagram, illustrating the run 101 and guide 102 use cases for users 103, students 119 121 of the institution as well as the faculty members 120 122. The use cases 104 are listed as providing for daily updates 108, planning and budgeting 109, trend analysis 110, multisource analysis 111, monitoring of key performance indicators 112. These functions are provided under the run 101 model of the invention. In the guide 102 model, the same set of functions are provided in an advanced way for daily updates 113, trend analysis 115, planning and budgeting 114, multisource analysis 116, key performance indicator determinations 117. In addition, the guide 102 version also provides predictive analysis 118 through the use and generation of analytics and insights. The run 101 version is analogous to basic version 106 while the guide 102 version is grouped with advanced 107 functions. These set of solutions 105 are provided for the benefit of school, college and university which is the subject of analysis.

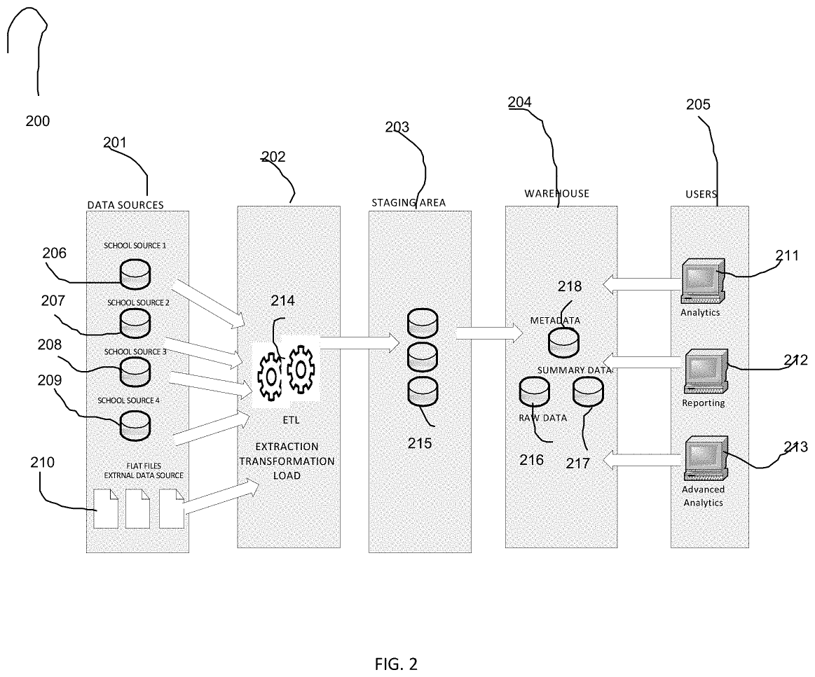

FIG. 2 200 illustrates as one embodiment of architecture of the software being proposed. Various data sources 201 comprising of school source 1 206, school source 2 207, school source 3 208, school source 4 209, and flat files 5 210. In the next step 202, extraction-step is undertaken using an ETL tool 214 to provide data in the staging area 203 and its database 215. In the next step 204, the staged data 215 is consolidated with warehouse 204 located big data in the form of metadata 218, summary data 216 and raw data 217. Using the staged data 215, and the warehouse 204 components, user desired analytics 211, advanced analytics 213 and reporting 212 steps are completed.

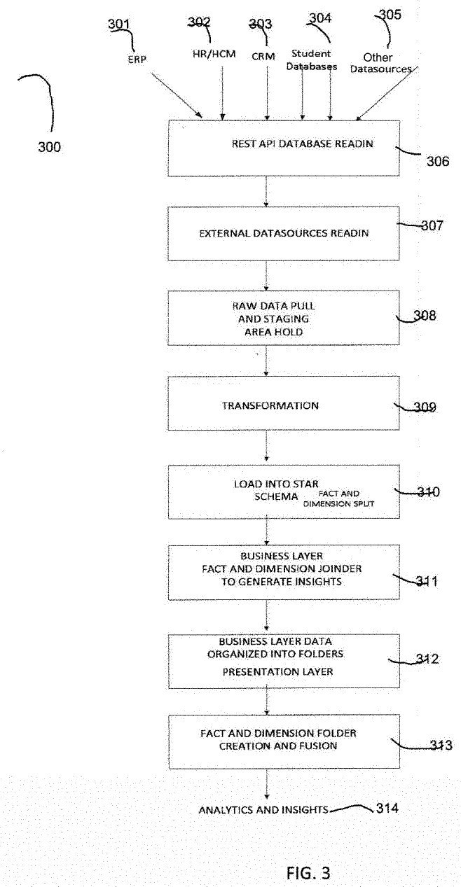

FIG. 3 300 is an exemplary illustration of the algorithmic steps involved in the database manipulations for the benefit of school, college or university. Inputs from data sources ERP 301, HR/HCM 302, CRM 303, student databases 304 and other data sources 305 are fed into the database manipulation system. The read in of these data sources occurs through REST API 306. Any external data resources are read in 307, say through a spreadsheet. The fed data is pulled and placed in a staging area 308. This data is transformed through the step of transformation 309. This is then fed into star schema 310 where there is a fact and dimension split. In the business layer function 311, there is a joinder of fact and dimension aspects of database to generate insights. In the presentation layer 312, the business layer data is organized into folders. The fact and dimension aspects are organized and fused 313 to create analytics and insights 314 to be able to run or guide the institution subject.

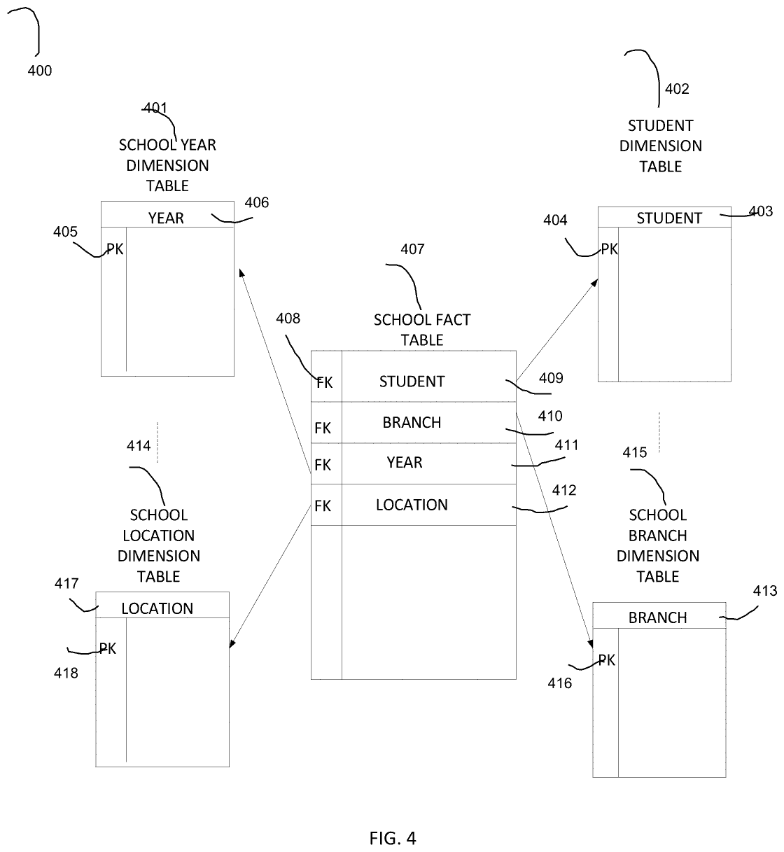

FIG. 4 400 is an exemplary illustration of a star schema for a single large fact table 407 and a plurality of dimension tables 401 402 414 415 for an educational institution (school) 407. In one embodiment, a fact table 407 for school showing facts or measurements for the category of year 411, location 412, branch 410 and student 409, among others. Each of the fact measured in a student 409, year 411, location 412 and branch 410 is linked or keyed to its corresponding smaller dimension table 401 402 414 415 though the use of a foreign key 408. For each of year 411, location 412, student 409 and branch 410, various attributes are stored in the dimension table, which serve as query category. The dimension table 401 402 414 415 has a physical key identifier 404 405 416 418 as a field for the dimension table 401 402 414 415. As an exemplary implementation, location 412 dimension table 414 may have attributes of zip code, county state and country. The fact table 407 is generally at the center of the star schema, whereas the dimension tables 401 402 414 415 are on the periphery or arm of the star. By organizing the data in this format, various queries and database accesses are supported to be used to stage and fuse data to gain insights and analytics for present and future analysis and predictions.

Embodiments as described herein as a framework system are exemplary. The examples provided above are illustrative only and are not intended to be limiting. One skilled in the art may readily devise other systems consistent with the disclosed embodiments which are intended to be within the scope of this disclosure. Although the present invention has been explained in relation to its preferred embodiment of being used for schools, colleges and universities, it is to be understood that many other possible modifications and variations can be made without departing from the spirit and scope of the invention as herein described.

What is claimed is:

1. An educational institution database system, comprising:
an inputting system capable of sourcing from a plurality of sources;
an extraction and staging of the input data;
a transformation of the extracted and staged data;
a load of the transformed data into a database schema and;
a joinder of fact and dimension components of the database schema and use of machine learning and big data to
generate overarching analytics and insights for all business flows of the educational institution.

2. The educational institution database system of claim 1 where the analytics and insights are used to run the institution.

3. The educational institution database system of claim 1 where the analytics and insights are used to provide strategic guidance to the institution using predictive analysis.

4. The educational institution database system of claim 1 where the machine learning includes supervised and unsupervised learning.

5. The educational institution database system of claim 1 where the database is capable of cloud installation and upgrade.

6. The educational institution database system of claim 1 where the database analysis is done for planning, budgeting, key performance indicators measurements, trend analysis and daily updates.

7. An educational institution database apparatus, comprising:
an inputting apparatus capable of sourcing from a plurality of sources;
an extraction and staging of the input data;
a transformation of the extracted and staged data;
a load of the transformed data into a database schema and;
a joinder of fact and dimension components of the database schema and use of machine learning and big data to generate overarching analytics and insights for all business flows of the educational institution.

8. The educational institution database apparatus of claim 7 where the analytics and insights are used to run the institution.

9. The educational institution database apparatus of claim 7 where the analytics and insights are used to provide strategic guidance to the institution using predictive analysis.

10. The educational institution database apparatus of claim 7 where the machine learning includes supervised and unsupervised learning.

11. The educational institution database apparatus of claim 7 where the database is capable of cloud installation and upgrade.

12. The educational institution database apparatus of claim 7 where the database analysis is done for planning, budgeting, key performance indicators measurements, trend analysis and daily updates.

13. An educational institution database method, comprising:
an inputting method capable of sourcing from a plurality of sources;
an extraction and staging of the input data;
a transformation of the extracted and staged data;
a load of the transformed data into a database schema and;
a joinder of fact and dimension components of the database schema and use of machine learning and big data to generate overarching analytics and insights for all business flows of the educational institution.

14. The educational institution database method of claim 13 where the analytics and insights are used to run the institution.

15. The educational institution database method of claim 13 where the analytics and insights are used to provide strategic guidance to the institution using predictive analysis.

16. The educational institution database method of claim 13 where the machine learning includes supervised and unsupervised learning.

17. The educational institution database method of claim 13 where the database is capable of cloud installation and upgrade.

18. The educational institution database method of claim 13 where the database analysis is done for planning, budgeting, key performance indicators measurements, trend analysis and daily updates.
